(19) United States
(12) Patent Application Publication
(10) Pub. No.: US 2013/0144689 A1
(43) Pub. Date: Jun. 6, 2013

(54) Aggregated Customer Grouping

(71) Applicant: Tam Phung, Forest Hills, NY (US)

(72) Inventor: Tam Phung, Forest Hills, NY (US)

(73) Assignee: Green Star Hub, Woodside, CA (US)

(21) Appl. No.: 13/312,059

(22) Filed: Dec. 6, 2011

(51) Int. Cl. G06Q 30/02

(52) U.S. Cl. 705/14.1

(57) ABSTRACT

Aggregation of customers allows sellers to offer better rates in exchange for more sales, greater diversity of sales, and possible new customers. Customer aggregation includes suggesting alternative products to customers, obtaining collective product requests sufficiently similar that sellers can offer discounts to that customer aggregation. A system expands upon a core collection of product requests, adding similar requests having a nearby “distance” from the core collection. The system generates an expanded collection of requests, both sufficiently similar that customers are comfortable with the expanded collection, and sufficiently sizable that sellers are comfortable offering bulk discounts. Aggregation also includes determining risk of actual customer participation, even after expressing agreement to expanded collection. Sellers can determine the risk borne when offering bulk discounts to customers requesting aggregated collection. Sellers can adjust pricing to account both for desired profit margin and for desired risk premium over price point providing that profit margin.

### BACKGROUND

In commercial transactions, it sometimes occurs that one or more suppliers can provide products or services at discounted rates, if only they had a sufficient number of customers for those products or services. Suppliers often cannot easily identify those customers who would, in aggregate, be sufficient to justify offering discounted rates for bulk commerce. Similarly, customers often cannot easily identify groups who, in aggregate, might command sufficient market power to be able to convince suppliers to provide desired products or services at discounted rates.

One case in which this presents a particular problem is that of capital improvements. When a building owner or tenant seeks to make capital improvements, it sometimes occurs that the cost of those improvements, for small projects, can be large enough to make the project untenable. If the project were larger, the savings developed from economies of scale, in combination with the savings developed from improvement in physical plant, can make the project worthwhile. In these circumstances, if individual owners making those improvements could band together, they might be able to obtain a volume rate from sellers.

Individual owners face both the difficulty of finding other such owners, and the difficulty that other such owners might have distinct needs which make aggregating their purchases more complicated. To obtain the best opportunity, those individual owners would want to agree on a common set of purchases to present to sellers. Distinctions between individual owners might include the amount of products they wish to obtain, the location at which they want to use them, and the amount of capital to be invested in making long-term cost reductions. For example, distinct owners might have differing desires regarding the energy-efficiency or other environmental friendliness of the improvements they wish to make, with the effect that they desire differing building products. Examples might include: different HVAC equipment, insulation, windows, and the like.

Known methods of group purchasing include aggregation of multiple buyers to obtain discounts from sellers. While these known methods generally achieve the goal of obtaining volume discounts, they have drawbacks as indicated above. They also have drawbacks in that they often involve the financial commitment of some number of buyers before sellers are willing to financially commit to better prices.

### SUMMARY OF THE DESCRIPTION

We provide techniques that assist aggregation of customers, with the effect that sellers can offer better rates, in the knowledge of garnering more sales in exchange. When aggregated, customers benefit from the better rates. Sellers benefit from a greater volume of sales, and possibly from a greater diversity of sales, and possibly from new or unexpected customers.

In a first aspect, aggregation includes suggesting alternative product requests, or altering those product requests, with the effect of constructing aggregate product requests sufficiently similar that sellers can offer discounts. A system expands upon a core collection of product requests, in response to requests having a nearby similarity distance from the core collection, with the effect of generating an expanded collection of product requests that is both sufficiently similar that customers will be comfortable with that expanded collection of product requests, and sufficiently sizable that sellers will be comfortable offering bulk discounts.

In a second aspect, aggregation includes determining a risk of actual customer participation in the expanded collection of product requests, even after having already expressed agreement. Customers might retract their agreement to the expanded collection of product requests. Sellers can determine the risk they bear when offering bulk discounts to customers associated with the aggregated collection of product requests. Sellers can adjust their pricing to account both for a desired profit margin and for a desired risk premium over a price point providing that profit margin.

In a third aspect, aggregation includes determining a measure of environmental friendliness associated with a customer, which measure is capable of matching with a vendor. Each customer can rate themselves with respect to environmental friendliness. Each customer is presented with a set of questions relating to choices they would make, such as lifestyle choices, which relate to environmental friendliness. Ambiguities are resolved using follow-up questions that distinguish between differing measures of environmental friendliness.

### BRIEF DESCRIPTION OF THE FIGURES

FIG. 1 shows a conceptual diagram of a system.

FIG. 2 shows a conceptual diagram of a method.

FIG. 3 shows a conceptual diagram of a method.

FIG. 4 shows a conceptual diagram of a method.

FIG. 5 shows a conceptual diagram of a method.

FIG. 6 shows a conceptual diagram of a method.

### DETAILED DESCRIPTION

### Figures and Text

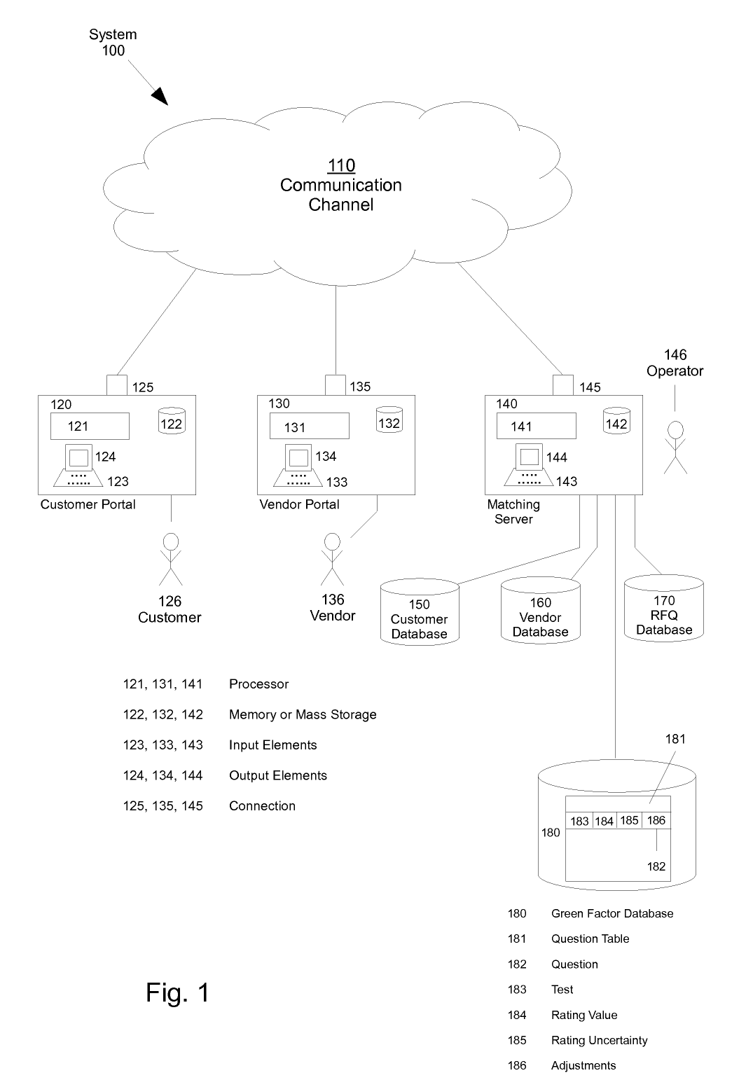

FIG. 1 shows a conceptual diagram of a system.

A system 100 capable of matching customers and vendors includes elements shown in the figure, including at least a communication channel 110, one or more customer portals 120, one or more vendor portals 130, and a matching server 140. The system 100 might include other and further elements, such as for example product databases, advisory services, or otherwise.

The communication channel no couples the customer portals 120, the vendor portals 130, and the matching server 140. The communication channel no might include a LAN, a WAN, or an enterprise network, or any other communication technique which allows contact between and among the devices using the system 100. In one embodiment, the communication channel no includes an Internet connection coupled to a web site managed by, or on behalf of, the matching server 140, as further described herein. In such cases, one or more of the customer portals 120 might communicate with the web site, and thus with the matching server 140, using an HTTP or HTTPS protocol, or a variant thereof. Similarly, in such cases, one or more of the vendor portals 130 might communicate with the matching server 140 using an HTTP or HTTPS protocol, or a variant thereof.

While this application primarily describes a system 100 in which customer portals 120 and vendor portals 130 communicate with the matching server 140 using the same communication channel 110, in the context of the invention, there is no particular requirement for any such limitation. For example, customer portals 120 might communicate with the matching server 140 using a 1^{st} web site, or using a web site managed by a 1^{st} web server, while vendor portals 130 might communicate with the matching server 140 using a 2^{nd} web site, or using a web site managed by a 2^{nd} web server. Moreover, distinct types of customers might have distinct customer portals 120, which communicate with the matching server 140 using distinct communication channels, and distinct types of vendors might have distinct vendor portals 130, which communicate with the matching server 140 using distinct communication channels. Also, after reading this application, those skilled in the art would recognize that some customers for one purpose might also be vendors for another purpose, and vice versa.

The customer portals 120 each include a processor 121, memory or mass storage 122 maintaining programs and data, input elements 123 such as a keyboard and pointing device, output elements 124 such as a monitor and speakers, a connection 125 to the communication channel no, such as for example an Internet connection, and are disposed to be used by one or more customers 126. For example, the customer portals 120 can include personal electronic devices, such as for example desktops, laptops, netbooks, touchpads, smart phones, or otherwise, and can include enterprise computing devices, such as for example servers, virtual machines, or otherwise.

Customer portals 120 can also include an aggregation or other marketplace of their own, such as for example a cooperative organization, an interinsurance exchange, a business entity which operates for the benefit of its members by aggregating their purchases and obtaining better market power thereby, or another type of group buying site or group buying organization. For example, a customer portal 120 could include a physical location, e.g., a “brick and mortar” location, in which one or more customer kiosks are located which facilitate buyers entering possible purchase requests and which facilitate aggregation of those requests. Customer portals 120 could serve to collect buyers' purchase requests, or indications of interest, or could serve to actually aggregate those requests, or indications of interest, before they are sent to the matching server 140.

Customer portals 120 can also include one or more web sites or other Internet services, which can be invoked from an application (such as by a smart phone or touchpad) or by an API or program at a customer server or customer web site. Each customer portal 120 can be disposed for use by a single customer 126, or for use by more than one customer 126, or more than one distinct agent of the same customer 126, such as for example distinct project managers for a single business entity.

The customer portals 120 operate under control of program elements, executed by the processor 121 and maintained in the memory or mass storage 122, which perform the functions described herein. References to the customer portals 120 performing a function generally refer to a combination of hardware elements (such as the processor 121 and memory or mass storage 122) and software elements (such as the program elements) operating in combination or conjunction to achieve the described function. The term “customer”, and variants thereof, generally refers to any entity that might engage in commerce, such as by purchasing (or offering to purchase) goods or services. A customer might include a direct purchaser such as a subcontractor, or an indirect purchaser such as a contractor or a building owner. As described elsewhere herein, while this application sometimes refers to commerce involving upgrades or retrofitting of buildings, in the context of the invention, there is no particular requirement for any such limitation.

In one embodiment, customers 126 can enter information describing products and services they are interested in, such by sending that information from the memory or mass storage 122, or entering that information using the input elements 123. For example, a customer 126 might describe that they wish to upgrade a set of plain glass windows with a set of insulated windows, or might describe that they wish to upgrade an older HVAC system with a new HVAC system. Customers 126 similarly can, in addition, or instead, enter information describing buildings they wish to upgrade or retrofit. For example, a customer 126 who has a building they wish to upgrade or retrofit might enter information about that building, including its age, construction type (such as for example concrete or wood), current use (such as for example office, retail, or warehousing). The customer 126 might also enter information about their costs (such as for example their utility bills, energy usage, or carbon footprint), information about their current willingness to make changes (such as for example a capital budget for upgrades, a time duration for completion of any upgrade or retrofit projection, or a degree of environmental friendliness desired for the project). The customer 126 need not enter all this information directly. The information might be supplied by another party, by reference to an external database, or might be inferred by the matching server 140 in response to a set of questions or another technique for obtaining information about the customer 126. Information relating to a building might be obtained from a public database, such as a city plans, tax records, or services like satellite mapping or street views of that area. Information about that building might be input to the matching server 140 using architectural drawings or building specifications. Cost information might be obtained from business financial statements, public utilities, or otherwise.

In one embodiment, cost information for one or more customers 126 can be maintained confidential by the matching server 140, at the request of those customers 126. For example, customers 126 might provide a range, or a lower or upper bound, for their capital budget. Optionally, customers 126 might provide a cost function which indicates a degree of perceived cost the customer 126 associates with aspects of the project. For example, the customer 126 might be willing to tolerate a limited time duration for a building upgrade, but might note that each day required for the upgrade will cost the customer 126 in lost sales (such as for a commercial building) or inaccessibility to the public (such as for a government building).

The vendor portals 130 each include a processor 131, memory or mass storage 132 maintaining programs and data, input elements 133 such as a keyboard and pointing device, output elements 134 such as a monitor and speakers, a connection 135 to the communication channel no, such as for example an Internet connection, and are disposed to be used by one or more vendors 136. For example, the vendor portals 130 can include personal electronic devices, such as for example desktops, laptops, netbooks, touchpads, smart phones, or otherwise, and can include enterprise computing devices, such as for example servers, virtual machines, or otherwise. Vendor portals 130 can also include one or more web sites or other Internet services, which can be invoked from an application (such as by a smart phone or touchpad) or by an API or program at a customer server or customer web site. Each vendor portal 130 can be disposed for use by a single vendor 136, or for use by more than one vendor 136, or more than one distinct agent of the same vendor 136, such as for example distinct project managers for a single business entity.

The vendor portals 130 operate under control of program elements, executed by the processor 131 and maintained in the memory or mass storage 132, which perform the functions described herein. References to the vendor portals 130 performing a function generally refer to a combination of hardware elements (such as the processor 131 and memory or mass storage 132) and software elements (such as the program elements) operating in combination or conjunction to achieve the described function. The term “vendor”, and variants thereof, generally refers to any entity that might engage in commerce, such as by selling (or offering to sell) goods or services. A vendor might include a direct seller such as a franchisee or retailer, or an indirect seller such as a manufacturer or wholesaler. As described elsewhere herein, while this application sometimes refers to commerce involving upgrades or retrofitting of buildings, in the context of the invention, there is no particular requirement for any such limitation.

In one embodiment, vendors 136 can enter information describing products and services they offer. For example, a vendor 136 who is a building contractor might describe products they offer for upgrading or retrofitting existing buildings to make them more energy efficient or otherwise more environmentally friendly. For each of these products or services, the vendor 136 would describe: (1) the nature of the product, and labor and materials associated with the product; (2) a green rating associated with the product; (3) a base cost and profit margin desired by the vendor 136 for that product; (4) possibly other information about the product. In one embodiment, vendors 136 can in addition, or instead, enter information describing types of buildings they offer to upgrade or retrofit. For example, a vendor 136 regularly upgrades or retrofits particular types of buildings might enter information about those types of building, including similar information as might have been entered by customers 126 desiring work on those types of buildings. The vendor 136 need not enter all this information directly. The information might be supplied by another party, by reference to an external database, or might be inferred by the matching server 140. Information relating to buildings upgraded or retrofit by a particular vendor 136 might be obtained in similar manner as that for a single building for a particular customer 126. Information relating to particular products (and their prices) available from a vendor 136 might be obtained from a catalog from that vendor 136, from a website associated with that vendor 136, or from affiliate websites offering products originally from that vendor 136. Energy efficiency information might be obtained from business financial statements, public utilities, or otherwise. A green rating for a vendor 136, for a project proposed by the vendor 136, or for the products to be used in the project proposed by the vendor 136, might be determined as described below.

In one embodiment, cost information for one or more vendors 136 can be maintained confidential by the matching server 140, at the request of those vendors 136. For example, vendors 136 might provide a range, or a lower or upper bound, for their pricing. Optionally, vendors 136 might provide a price margin function which indicates a degree of desired margin the vendors 136 associates with aspects of the project. For example, the vendors 136 might be willing to accept a lesser margin per item, or per labor hour, so long as the total number of items, or labor hours, is sufficient that the total sale is profitable.

The matching server 140 includes a processor 141, memory or mass storage 142 maintaining programs and data, and a connection 145 to the communication channel 110, such as for example an Internet connection. The matching server 140 optionally includes input elements 143 such as a keyboard and pointing device, output elements 144 such as a monitor and speakers, and is disposed to be used by one or more matching operators 146, such as for example conducting operations at the behest of a matching service entity. In one embodiment, the matching server 140 includes a web server coupled to the Internet and capable of receiving and responding to responses from web browsers.

The matching server 140 operates under control of program elements, executed by the processor 141 and maintained in the memory or mass storage 142, which perform the functions described herein. References to the matching server 140 performing a function generally refer to a combination of hardware elements (such as the processor 141 and memory or mass storage 142) and software elements (such as the program elements) operating in combination or conjunction to achieve the described function.

References in this Application to functions performed by the matching server 140 can also be performed at other devices, either at the request of the matching server 140, or to assist the matching server 140. For example, vendors 136 can perform repricing or determine their own risk margin directly, and can assist the matching server 140 in its functions.

The term “matching server”, and variants thereof, also generally refers to any entity that might provide the services described herein, whether as a public service or as a business. For example, the matching server 140 might be operated as a business entity, in which the service of matching customers 126 and vendors 126 is performed by the matching server 140, and in which the business entity collects a fee for matching. As described herein, the matching server 140 constructs aggregated RFQ's in response to individual RFQ's provided by individual customers 126, determines a savings to individual customers 126 due to an aggregated vendor offer associated with those aggregated RFQ's, distributes that savings among the customers 126 participating in the aggregated RFQ, and optionally reserves a portion of that savings for itself.

The matching server 140 attempts to aggregate RFQ's in response to a set of parameters, such as those described herein: (1) goals, including upgrade or retrofit needs, such as nature of the building project; (2) costs, such as those that are expressed in monetary cost, energy usage, and carbon footprint; (3) expendable effort, such as those expressed in capital investment, time to completion, and green rating. The parameters can, but need not, be independent or orthogonal in nature. For example, capital investment the customer 126 is willing to expend, and time to completion the customer 126 is willing to endure, might be positively correlated. Collectively, the parameters can define a possible aggregation of customers 126 (or particular customer projects). For selected tradeoffs between pairs of parameters, some pairs of customers 126 or customer projects might be relatively well suited for possible aggregation, while other pairs of customers 126 or customer projects might be relatively unsuited. For example, two customers 126 with nearly identical needs, costs, and willingness to expend effort (including green rating), would be likely to be relatively suited for aggregation, while two customers 126 with very different needs, costs, and willingness to expend effort, would not. Collectively, each vendor 136 (or particular vendor product or project) can also be measured for suitability for possible aggregation of customers 126 (or customer projects). For selected tradeoffs between pairs of parameters, some vendors 136 might be particularly suitable, while other vendors 136 might be unsuitable.

In one embodiment, the matching server 140 includes a customer database 150, a vendor database 160, an request for quote (RFQ) database 170, and a “green rating” database 180, in one embodiment, each maintained in the memory or mass storage 142. Alternatively, one or more of these databases might be maintained at another location, logically or physically remote from the matching server 140, such as for example a storage device or a database server.

The customer database 150 includes a customer entry for each customer 126 (optionally, for each set of customers 126 who wish to band together before operation of the matching server 140). Each customer entry is associated with a set of RFQ's in the RFQ database 170. In one embodiment, each customer entry is associated with a set of RFQ's for the customer 126, possibly including aggregated RFQ's, as described below, which are themselves associated with more than one customer 126.

Similarly, the vendor database 160 includes a customer entry for each vendor 136 (optionally, for each set of vendors 136 who wish to band together before operation of the matching server 140). Each vendor entry is associated with a set of vendor offers in the RFQ database 170. In one embodiment, each vendor offer is associated with a set of customers 126 who have been presented with the vendor offer, or who have accepted the vendor offer, or otherwise.

Similarly, the RFQ database 170 includes an RFQ entry for each RFQ, including for each individual RFQ associated with a single customer 126, and for each aggregated RFQ associated with more than one customer 126. The RFQ database 170 also includes a vendor offer entry for each vendor offer, including for each individual vendor offer associated with an individual RFQ, and each aggregated vendor offer associated with an aggregated RFQ. The matching server 140 uses the RFQ database 170 to match and aggregate RFQ's, to track vendor responses to aggregated RFQ's, to track customer responses to those aggregated vendor offers, and to maintain risk margin information, as further described herein.

The green rating database 180 includes a green value for each customer 126, and in one embodiment, for each vendor 136, for each type of green rating (environmental friendliness, animal friendliness, child safety, and otherwise). In one embodiment, the green rating database 180 also includes a question lookup table 181, as further described herein for adjusting the green value associated with a customer 126 in response to an interactive dialog with that customer 126. As further described herein, the question lookup table 181 includes a set of questions 182, each of which is associated with a question text 183, a rating value 184 for when to ask that question, a rating uncertainty 185 for when to ask that question, and a set of adjustments 186 associated with distinct possible answers to that question 182.

Green Ratings

In one embodiment, the system 100 determines a degree of environmental friendliness desired for the customer 126, or for an individual customer project (as described by an individual RFQ), sometimes referred to herein as a “green rating”. The green rating can help the customer 126 evaluate their home or business for potential environmentally friendly improvements, and help facilitate bidding between and among contractors and other vendors 136, which might help reduce costs for labor and materials, and help the customer 126 select superior environmentally friendly products and technologies. The system 100 might determine the green rating in response to a number of possible factors.

The phrase “green rating”, and variants thereof, generally refers to any technique by which customers 126 can be distinguished with respect to their environmental friendliness. For example, such techniques might include a numerical scale, a set of categories, or otherwise. As further noted herein, a “green rating” can also refer to another measure for a project. For example, a distinct type of green rating might refer to distinguishing with respect to animal friendliness, child safety, or as otherwise described herein. While this application generally uses “green rating” to refer to environmental friendliness, in the context of the invention, there is no particular reason for any such limitation. After reading this application, those skilled in the art would recognize that these other alternative factors are also within the scope and spirit of the invention.

For example, with respect to environmental friendliness, in one embodiment, the system 100 might use the following set of green ratings:

1 leaf: The customer 126 does not assign any significant positive weight to environmental friendliness, and is not willing to endure any significant financial burdens to achieve environmentally friendly results. An example of a 1 leaf customer might be a bankruptcy trustee mandated by law to maximize returns to creditors.
2 leaves: The customer 126 assigns very little weight to environmental friendliness, and is willing to endure some, but not large, financial burdens to achieve environmentally friendly results. An example of a 2 leaf customer might be a homeowner association whose members are concerned about the environmentally friendly nature of their community.
3 leaves: The customer 126 assigns some weight to environmental friendliness, and is willing to endure a medium degree of financial burden to achieve environmentally friendly results. An example of a 3 leaf customer might be public utility seeking political approval of a controversial project.
4 leaves: The customer 126 assigns significant weight to environmental friendliness, and is willing to endure large, but not extreme, financial burdens to achieve environmentally friendly results. An example of a 4 leaf customer might be a political party for which environmental concerns are part of its national agenda.
5 leaves: The customer 126 assigns extreme weight to environmental friendliness, and is willing to endure relatively heavy financial burdens to achieve environmentally friendly results. An example of a 5 leaf customer might be a government agency constrained by law to stay within mandated environmental limits.

While green ratings are described above as being whole numbers from 1 to 5, in the context of the invention, there is no particular requirement for any such limitation. For example, green ratings might include decimal or fractional values, symbolic values, or otherwise. Similarly, while green ratings are described above using symbols such as leaves, in the context of the invention, there is no particular requirement for any such limitation. For example, green ratings might be described using coins, or any other icon or picture, or any other symbol (or no symbol at all) which is recognizable by customers 126 or by vendors 136.

The phrase “environmental friendliness”, and variants thereof, generally refers to any measure of how the project, or its deportment, affects environmental factors, including without limitation with respect to energy-efficiency, carbon footprint, pollutants, toxic substances, effects on community, effects on flora and fauna, effects on light and air, and otherwise. Environmental friendliness can include effects due to manufacture, transport, commerce in, or use of particular products and services. For example, with respect to a set of window panes, environmental friendliness can include their energy-efficiency, the substances incorporated into those products, a measure of waste associated with their manufacture, and otherwise.

In one embodiment, in response to information about the customer 126, as described above, the system 100 attempts to classify the customer 126 into a green rating category. The system 100 interacts with the customer 126, such as using a software element at the customer portal 120, or a software element at the matching server 140, or otherwise. The software element presents a set of choices to the customer 126, receives one or more responses from the customer 126, and in response thereto, continues with a next set of choices to present.

In one embodiment, the interaction with the customer 126 (presentation of choices, reception of one or more responses) is repeated until the system 100 has determined a green rating for the customer 126 with sufficient confidence to associate that green rating with the customer 126. Optionally, the system 100 might associate the green rating with the project requested by the customer 126, again, with sufficient confidence to associate that green rating with that project.
In one embodiment, the system 100 directly asks the customer 126 to rate themselves on a scale indicative of environmental friendliness. For example, a “1 leaf” customer 126 might state that they only care about financial factors relating to the project, while a “5 leaf” customer 126 might state that they want to minimize carbon footprint even if that involves a heavy financial cost.

If the customer 126 is not sure about rating themselves, or if the system 100 wishes to confirm the self-rating by the customer 126, the system 100 asks the customer 126 a set of questions with respect to environmental friendliness.
In one embodiment, the system 100 asks the customer 126 about lifestyle factors which pertain to the customer 126 and which directly pertain to environmental friendliness, such as for example whether the customer 126 owns an electric vehicle or has home solar panels. The choices presented offer the customer 126 an opportunity to describe themselves by implication. In such cases, the choices presented are selected for statistical correlation with classification of customers 126 with respect to environmental friendliness. For example, the system 100 would ask if the customer 126 owns an electric vehicle if the answer to that question would be statistically correlated with a likelihood that the customer 126 would give greater or lesser weight to environmental friendliness.

Statistical measures of lifestyle choices are commercially available, which can be used by the system 100 to compute a measure of environmental friendliness in response to product preferences expressed by the customer 126. For example, there are known collaborative filtering techniques used in the advertising industry which assign prospective clients to one of several “values and lifestyle” categories. In one embodiment, the system 100 assigns a green rating to each one of those values and lifestyle categories.

If the system 100 is able to obtain a green rating for the customer 126 in response to the self-rating of the customer 126 and in response to the direct lifestyle factors, it uses that green rating. If the system 100 wishes to confirm the green rating it is able to determine in response to those factors, it proceeds to asking the customer 126 about indirect lifestyle factors.
In one embodiment, the system 100 asks the customer 126 about lifestyle factors which pertain to the customer 126 and which only indirectly pertain to environmental friendliness, such as for example a zip code or census tract in which the customer 126 resides, or a political party affiliation associated with the customer 126.

Similar to the direct lifestyle factors, the choices presented offer the customer 126 an opportunity to describe themselves by implication. The choices presented are selected for statistical correlation with classification of customers 126 with respect to environmental friendliness. For example, the system 100 would ask if the customer 126 has contributed to a political candidate known to favor issues which relate to environmental friendliness, if the answer to that question would be statistically correlated with a likelihood that the customer 126 would give greater or lesser weight to environmental friendliness.

If the system 100 is able to obtain a green rating for the customer 126 in response to the self-rating of the customer 126 and in response to the direct lifestyle factors, it uses that green rating. If the system 100 wishes to confirm the green rating it is able to determine in response to those factors, it proceeds to asking the customer 126 about indirect lifestyle factors.
In each case, the system 100 resolves ambiguities using follow-up questions. For example, if the customer 126 responds to lifestyle questions with answers that are at a border for classification between distinct green ratings (for example, some of the customer's answers would be associated with a 2-leaf green rating while others of the customer's answers would be associated with a 4-leaf green rating), the system 100 groups the customer's answers into (1) those answers which are associated with a 2-leaf green rating, versus (2) those answers which are associated with a 4-leaf green rating, and (3) attempts to find further lifestyle questions which best distinguish between those groupings.

In one embodiment, the system 100 maintains a default rating, such as “3 leaves”, when the system 100 has no information yet about the customer 126. Optionally, the default rating might be adjusted in response to a region in which the customer 126 is located, so that a 1^{st} region might have a default rating of 3.50 leaves, while a 2^{nd} region might have a default rating of 2.75 leaves, and a 3rd region might have a default rating of 3 leaves.

In one embodiment, as the system 100 gleans information about the customer 126, the system 100 adjusts the green rating associated with that customer 126 and a measure of uncertainty about that green rating. The system 100 continues to ask questions of the customer 126, the questions being selected in response to their current adjusted green rating, until answers from the customer 126 include sufficient information that the system can reduce that measure of uncertainty about their green rating to below a selected threshold. Once the system 100 has an adjusted green rating for the customer 126 and the measure of uncertainty is sufficiently low, the system 100 can stop questioning the customer 126 to ascertain their green rating.

In one embodiment, the system 100 applies fuzzy logic to select questions in response to the customer's 126 adjusted green rating. Alternatively, the system 100 may use the customer's 126 adjusted green rating to select a next question from a 100k-up table. For example, the system 100 might maintain a set of questions for each green rating, and associate the customer 126 with a particular green rating when the customer 126 answers “Yes” to more than X questions in one of the green ratings. For example, X might equal 3, thus, the system 100 would associate the customer 126 with a 2 leaf green rating after receiving 3 “Yes” answers to questions that are themselves associated with a 2 leaf green rating.
In one embodiment, the system 100 might also associate a rating with the customer 126 in response to the products they request for themselves or for a building they own. For example, if a customer 126 requests solar panels for their home, the system 100 might associate a more environmentally friendly green rating than if the customer 126 requests constructing a new swimming pool.

In one embodiment, the system 100 (either using a software element at the customer portal 120 or at the vendor portal 130, or a software element at the matching server 140) interacts with the vendor 136 and determines a degree of environmental friendliness assessed for the project, also referred to herein as a “green rating”. The green rating can help the vendor 126 match their product offerings to potential environmentally conscious customers 126, and help facilitate aggregation of similar customers 126, which might help reduce costs for labor and materials, and help the vendor 136 aggregate similar customers 126 and technologies. The system 100 might determine the green rating in response to a number of possible factors:
The system 100 might calculate, or otherwise determine, a green rating for the vendor 136, in response to a reputation poll of customers 126 who rate the vendor 126, the project proposed by the vendor 136, or the products to be used in the project proposed by the vendor 136, on a scale indicative of environmental friendliness.

In one embodiment, the system 100 might facilitate the reputation poll of customers 126 using a social networking feature, in which each particular vendor 136 is associated with comments and ratings from a set of customers 126 who rate the vendor 136, the project proposed by the vendor 136, or the products to be used in the project proposed by the vendor 136. In such cases, customers 126 whose ratings are themselves rated as “helpful” or “not helpful” might themselves have their ratings of vendors 136 weighted more or less, as indicated by their fellow customers 126.
The system 100 might calculate, or otherwise determine, a green rating for the vendor 136, in response to a set of customers 126 associated with that vendor 136, such as for example (1) green ratings assessed themselves by those customers 126; (2) lifestyle factors which pertain to those customers 126 and which directly pertain to environmental friendliness, as described above; (3) lifestyle factors which pertain to those customers 126 and which only indirectly pertain to environmental friendliness, as described above.

In one embodiment, the system 100 might obtain a statistical distribution of customers 126 for each vendor 136, and compute an average of green ratings for those customers 126 to obtain a green rating for that vendor 136. Similarly, the system 100 might compute a weighted average of green ratings for those customers 126, each customer 126 having a weight associated with a fraction of that vendor's sales which that customer 126 accounted for, or optionally, a weight associated with the fraction of that vendor's different products which that customer 126 used.
The system 100 might calculate, or otherwise determine, a green rating for the products offered or sold by the vendor 136, in response to a set of metrics associated with those products, such as for example energy efficiency, carbon footprint, and fraction of those products offered or sold by that vendor 136.
The system 100 might calculate, or otherwise determine, a green rating for the vendor 136, or for products offered or sold by the vendor 136, in response to a rating from a rating agency, such as for example the Department of Energy, EPA, or another government agency, or for example a consumer products rating agency or other private rating agency, such as the LEED rating system by the US Green Building Council.

In one embodiment, the system 100 uses a set of green ratings similar to those it associates with customers 126.

In one embodiment, it is contemplated that both customers 126 and vendors 136 would be involved in a project relating to a building, or a portion of the building, to upgrade or retrofit that building. Accordingly, vendors 136 would offer one or more collections of products and services related to upgrading or retrofitting that building, and customers 126 would one or more of those collections, or some portion of one or more of those collections. Distinct collections might vary in price and in energy saved for the customer 126, and in set of green ratings for the products and services in that collection, or in a green rating for the collection considered as a whole.

For example, a vendor 136 might offer (1) a set of insulated windows, and installation of those windows, to replace the windows already installed in the building, and (2) a retrofit of the HVAC and water-heating system, including new heating and cooling elements, ductwork, fans, pipes, pumps, and related equipment.

### Determining Green Rating

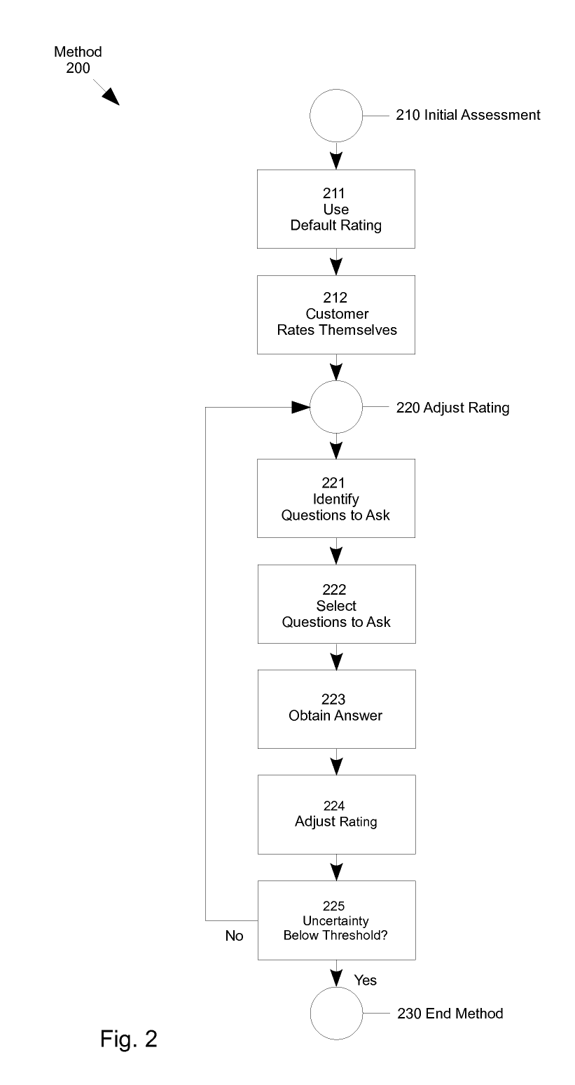

FIG. 2 shows a conceptual diagram of a method.

A method 200 includes flow points and steps as shown in the figure, including at least flow points as described below.

Initial Assessment:

At a flow point 210, the method 200 is ready to make an initial assessment of the customer 126.

At a step 211, the method 200 associates the customer 126 with a default green rating and an uncertainty for that green rating. As described above, the default green rating might be adjusted in response to location or other factors. The uncertainty might also be adjusted in response to location or other factors.

At a step 212, the method 200 optionally asks the customer 126 to rate themselves with a green rating.

Rating Adjustment:

At a flow point 220, the method 200 is ready to adjust the green rating in response to questions.

At a step 221, the method 200 identifies a set of questions in response to the current green rating and uncertainty. As described above, the questions might relate to lifestyle factors which directly or indirectly pertain to the green rating.

At a step 222, the method 200 selects one of those questions and asks the customer 126.

As described herein, the method 200 reviews the question 100k-up table 181 with a set of questions 182, each of which has an associated question text 183. Each of those questions 182 has an associated green value 184, optionally an associated uncertainty 185, and an associated set of adjustments 186 associated with distinct possible answers to that question 182.

If a particular question 182 is sufficiently close to the current green value (and optionally, uncertainty), the question 182 is eligible for asking. In one embodiment, the method 200 selects one such question 182 from the question 100k-up table 181 that is eligible for asking, either using a random or pseudorandom technique, or using a fuzzy logic technique. The fuzzy logic technique can be applied in response to the question 182, metadata about the question 182, and other information about the customer 126. Having selected one such question 182, the method 200 presents that question 182 to the customer 126. Optionally, a question 182 might be applied to information about the customer 126, without the requirement that the customer 126 actually review and answer it.

At a step 223, the method 200 obtains an answer (or refusal to answer) from the customer 126. In one embodiment, each question 182 has a 1^{st} adjustment 186 associated with a “Yes” answer, and a 2^{nd} adjustment 186 associated with a “No” answer, and optionally a 3^{rd} adjustment 186 associated with refusal to answer or associated with a non-meaningful answer. Alternatively, the question 182 could be multiple-choice, and have a distinct adjustment 186 associated with each possible response, including a failure to respond.

At a step 224, the method 200 adjusts the customer's green rating, and the uncertainty associated with the customer's green rating, in response to the customer's answer, and in response to the adjustment 186 described with respect to the earlier step 223.

At a step 225, the method 200 determines if the uncertainty associated with the customer's green rating is below a selected threshold, such as for example no more than 0.2 leaves. If so, the method 200 proceeds with the flow point 230, where it is effectively complete and finishes up. Otherwise, the method 200 continues with the flow point 220, where the method 300 continues to further adjust the customer's green rating.

At a flow point 230, the method 300 is effectively complete for this customer 126. The method 300 records the customer's green rating in a data structure at the matching server 140 (or optionally, at a database accessible to the matching server 140), and stops.

While this description has primarily been with respect to environmental friendliness, the system 100 might also rate customers 126 and vendors 136 with respect to other factors, such as for example (1) animal friendliness, e.g., customers 126 might prefer vendors 136 which are more friendly to animal safety or welfare, or which are vegetarian or vegan in their origin; (2) child safety, e.g., customers 126 might prefer vendors 136 which are more concerned about child safety, or which have better compliance records with child safety laws; (3) human rights, e.g., customers might prefer vendors 136 which produce their products according to the standards of one or more human rights ratings, such as those vendors 136 which abstain from manufacture in particular countries; (4) minority-owned businesses, e.g., customers 126 might prefer vendors 136 which are minority-owned or minority-controlled, or which have an active affirmative action plan; (5) political standing, e.g., customers 126 might prefer vendors 136 which are more unionized or less unionized, or which lean more toward the Democratic party or the Republican party; (6) religious affiliation, e.g., customers 126 might prefer vendors which have a particular religious affiliation, or which do not have any particular religious affiliation; (7) other standards that customers 126 might define. The system 100 might also provide combined ratings for vendors 136 in response to more than one of these or other factors. Naturally, the system 100 does not participate with ratings which are prohibited by law.

These alternative factors are sometimes referred to herein as “green factors”.

### Matching and Aggregation

The matching server 140 generally collects customers 126 (sometimes called “buyers”) into a set of aggregated RFQ's (requests for quotes), for vendors 136 (sometimes called “sellers”) to bid on those aggregated RFQ's. Each aggregated RFQ represents a set of customers 126 with a combination of parameters (goals, costs, and effort) which are sufficiently similar that the matching server 140 can present those of customers 126 to a particular vendor 136 for a group offer.

Collectively, a single aggregated RFQ is presented to a vendor 136 on behalf of a number of customers 126. The matching server 140 collects the sets of parameters (needs, costs, efforts) for each customer 126 and attempts to create a single aggregated RFQ which represents that group of customers 126. This has the effect that the matching server 140 combines RFQ's from each individual customer 126 into an aggregated RFQ on behalf of a group of customers 126.

Aggregated RFQ's are formed in response to the vendor's ability to support a region where the customers 126 are located. The matching server 140 maintains information from each vendor 136 regarding a coverage area, such as a list of zip codes, a radius from the main office of the vendor 136, or a set of locations indicated by the vendor 136 as their coverage area. Optionally, coverage areas would apply primarily to labor, as materials might be shipped in from relatively remote locations.

Aggregated RFQ's are formed in response to desired materials, including amounts that could be shipped, any shipping charges, or time delays associated with shipping. Customers 126 desire a set of materials to be included in their projects, such as for example, (1) a set of solar panels, (2) a set of energy-efficient lighting. While the particular materials to be included generally have to match those requested by the customer 126, the amounts can be aggregated by summing across multiple customers 126. For example, if a 1^{st} customer 126 desires 10 solar panels and 5 lighting systems, while a 2^{nd} customer 126 desires 20 solar panels but no lighting systems, a vendor 136 might make a group offer for solar panels and 5 lighting systems, with the customers 126 to divide up the materials.

Aggregated RFQ's are formed in response to desired financial terms, including amounts to be paid up front, amounts of time to be paid, at what progress points, and any interest rate. Vendors 136 such as general contractors offer financial terms for their projects. While financial terms offered by vendors 136 generally have to be matched by customers 126 who wish to accept the vendor's group offer, the amounts can be aggregated by summing across multiple customers 126. Thus, if a 1^{st} customer 126 is willing to pay 10% up front for a $100,000 project (thus, $10,000), while a 2^{nd} customer is willing to pay 5% up front for a $500,000 project (thus, $25,000), a vendor 136 might have a group offer accepted if the amount paid up front is at most the total (thus, $35,000).

Aggregated RFQ's are formed in response to desired time for performance, as described herein. In one embodiment, each Aggregated RFQ has an allowed time for customer 126 to join an aggregation (T₁), a deadline for vendors 136 make a group offer (T₂), a deadline set by a vendor 136 by which customers 126 must respond to the group offer (T₃), a deadline for the vendor 136 to ratify the group offer (T₄), and a deadline by which the vendor 136 promises to perform (T₅). Other associated times might exist, such as an extended acceptance time at less favorable terms, or an extended performance time with a late penalty, and otherwise.

Aggregated RFQ's are formed in response to green rating (or “green rating” with respect to other factors, as noted above), if the customers 126 associated with those aggregated RFQ's place decision-making weight on one or more “green ratings”, with the effect that customers 126 whose green rating is similar are more likely to be associated with an aggregated RFQ, and those aggregated RFQ's are more likely to be associated with vendors 136 whose green rating is compatible with those customers 126.

Aggregated RFQ's are adjusted with respect to industry, such as if the customers 126 are mostly grocery stores or if the customers 126 are mostly industrial buildings.

Aggregated RFQ's might optionally be adjusted with respect to customer preferences, such as for example if a particular customer 126 requests a particular vendor 136 as being preferable, due to a positive earlier experience, or otherwise.

Those skilled in the art would see that Aggregated RFQ's are formed or adjusted responsive to all measurable parameters which might be used as parameters for each customer 126 (or customer project). This has the effect that each factor associated with customers 126 is used to determine whether a set of customers 126 are relatively suited for aggregation. In one embodiment, factors would include: location of project, size of project, time urgency, green rating, and otherwise.

In one embodiment, customer aggregation is described with respect to three distinct types of RFQ's, (1) time and materials RFQ's, (2) commodity RFQ's without tiered pricing, and (3) commodity RFQ's with tiered pricing.

In any case in which a customer 126 submits an RFQ, the matching server 140 determines T₁ (deadline to join an aggregation), T₂ (deadline for making vendor offers), T₃ (deadline for accepting vendor offers), T₄ (deadline for vendor to ratify the aggregated RFQ), and T₅ (deadline for vendor performance). As to T₁, T₂, T₃, and T₄, the matching server 140 enforces those due dates by only aggregating RFQ's and matching them with aggregated vendor offers within those times. As to T₅, the matching server 140 can enforce that due date only with respect to a price differential that might be specified if the vendor does not perform within that time.

(1) With respect to time and materials RFQ's, the matching server 140 generally collects RFQ's into aggregated RFQ's when possible, determines if there is an aggregated vendor offer for each aggregated RFQ, and if so, facilitates the conduct of buyers and the vendor for that aggregated vendor offer. For each buyer entering the aggregated RFQ, the matching server 140 determines the risk margin. If the risk margin is paid, the matching server 140 enters that buyer unequivocally into the aggregated RFQ, with the risk margin being nonrefundable earnest money by the buyer that compensates the vendor if the buyer were not to go through with the aggregated RFQ. If the risk margin is not paid, the matching server 140 can enter the buyer into the aggregated RFQ, but notes that the buyer can later be removed from the aggregated RFQ, such as if the vendor is not satisfied with the possibility that buyers will pull out of the aggregated RFQ.

(2) With respect to commodity RFQ's without tiered pricing, the matching server 140 generally collects RFQ's into aggregated RFQ's when possible. The vendor has generally presented an aggregated vendor offer which has a minimum quantity associated with it, such as described herein. For example, the vendor could offer a 20% discount if the aggregated RFQ includes at least 1,000 units of product. For each buyer entering the aggregated RFQ, the matching server 140 determines the risk margin. If the risk margin is paid, the matching server 140 enters that buyer unequivocally into the aggregated RFQ, as described above. If the risk margin is not paid, the matching server 140 can enter the buyer into the aggregated RFQ, but notes that the buyer can later be removed from the aggregated RFQ, as described above.

If the risk margin is paid for a sufficient quantity, the aggregated RFQ proceeds. If the risk margin is not paid for a sufficient quantity, the matching server 140 determines if it would be valuable to pay the remaining risk margin itself, and resell the quantity of product that buyers have not unequivocally covered. For example, if the vendor offered a 20% discount if the aggregated RFQ includes at least 1,000 units of product, but only 900 units of product were guaranteed by buyers, the matching server 140 might pay the risk margin for the remaining 100 units of product, and attempt to resell those units itself, at a price between the aggregated RFQ price and the full retail price. This is described below as a “hot RFQ”.

In any case in which the aggregated RFQ has an aggregated vendor offer, and the deal proceeds, the matching server 140 allocates the savings from the aggregated RFQ to the buyers associated with that aggregated RFQ, as described herein. The initiating buyer, that is, the 1^{st} buyer to submit an individual RFQ, is allocated 5% of the savings as an incentive to buyers to initiate new RFQ's that might become aggregated RFQ's. The rest of the savings are allocated to the buyers in proportion to their participation in the aggregated RFQ. Optionally, the matching server 140 might allocate a portion of the savings to itself, and distribute the rest of the savings to the buyers.

(3) With respect to commodity RFQ's with tiered pricing, the matching server 140 generally collects RFQ's into aggregated RFQ's when possible. The vendor has generally presented an aggregated vendor offer which has a minimum quantity associated with it, such as described herein. For example, the vendor could offer a 10% discount if the aggregated RFQ includes at least 500 units of product, a 20% discount if the aggregated RFQ includes at least 1,000 units of product, and a 25% discount if the aggregated RFQ includes at least 1,500 units of product. For each buyer entering the aggregated RFQ, the matching server 140 determines the risk margin. If the risk margin is paid, the matching server 140 enters that buyer unequivocally into the aggregated RFQ, as described above. If the risk margin is not paid, the matching server 140 can enter the buyer into the aggregated RFQ, but notes that the buyer can later be removed from the aggregated RFQ, as described above. If the risk margin is paid, the aggregated RFQ proceeds for that quantity.

In any case in which the aggregated RFQ has an aggregated vendor offer, and the deal proceeds, the matching server 140 allocates the savings from the aggregated RFQ to the buyers associated with that aggregated RFQ, as described herein. The initiating buyer, that is, the 1^{st} buyer to submit an individual RFQ, is allocated 5% of the savings as an incentive to buyers to initiate new RFQ's that might become aggregated RFQ's. The rest of the savings are allocated to the buyers in proportion to a formula described herein. In one embodiment, the formula allocates exponentially greater savings to buyers when those buyers participate more towards savings due to the aggregated RFQ. Optionally, the matching server 140 might allocate a portion of the savings to itself, and distribute the rest of the savings to the buyers.

### Customer Aggregation

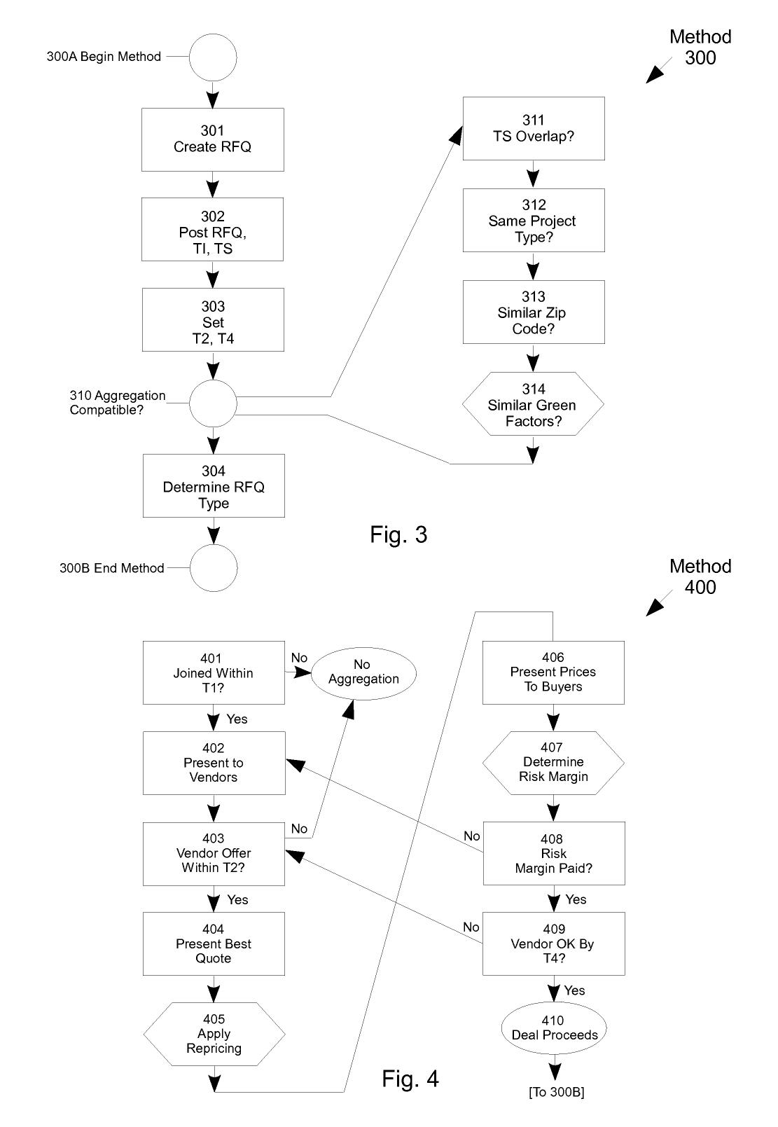

FIG. 3 shows a conceptual diagram of a method. A method 300 includes steps as shown in the figure, including at least steps as described below.

A flow point 300A indicates a beginning of the method 300.

At a step 301, a customer 126 finds a product or service at the matching server 140. In response to the customer 126, the matching server 140 creates an RFQ for possible aggregation. Alternatively, an RFQ might be created in response to an operator of the matching server 140 or another entity tasked with creating RFQ's, such as an audit partner or a customer service representative for the matching server 140 (which can itself be operated as a separate business entity), and the method 300 proceeds with the step 310. Alternatively, a customer 126 might inquire about a product or service not available at the matching server 140, which might result, after the matching server 140 determines if a similar product or service is available, in a new RFQ being created for the similar product or service.

At a step 302, the RFQ is posted on the matching server 140, and given an identifying number. The initiating customer 126, who created the RFQ, or the operator if there was no such customer 126, sets values for T₂ (deadline for making a group offer) and T₅ (deadline for performance).

At a step 303, the customer 126 and an operator jointly set values for T₁ (deadline for joining aggregation) and for T₄ (deadline for ratifying group offer). For example, the customer 126 might select values in response to a set of values suggested by the operator, or the customer 126 might just set the values themselves.

A flow point 310 indicates the method 300 is ready for an aggregation compatibility check.

For each aggregated RFQ, whether for times and materials RFQ's, commodity RFQ's without tiered pricing, or commodity RFQ's with tiered pricing, the method 300 performs an aggregation compatibility check. In general, each new RFQ, or each attempt to join an RFQ to an existing aggregated RFQ, is checked for compatibility with the existing aggregated RFQ. In one embodiment, the method 300 performs the following checks substantially in parallel. In one embodiment, these checks are performed by the matching server 140, or by another computing device at the request of the matching server 140.

At a step 311, the method 300 determines if the T₅ values for the new RFQ and the aggregated RFQ overlap. If so, the new RFQ is eligible for aggregation.

At a step 312, the method 300 determines if the project type is the same. For a 1^{st} example, for projects in which labor is required, such as time-and-material projects, the location for the projects should be within driving distance, and the type of labor involved should be similar. For a 2^{nd} example, for projects in which products are being delivered, the delivery location should be within shipping distance. Alternatively, the sending location should be sufficiently similar that a vendor 136 would be willing to undertake the delivery. If the project type is the same, the new RFQ is eligible for aggregation.

At a step 313, the method 300 determines if the zip code for the project is similar. In performing this action, the method 300 can use a database of zip codes, indicating for each zip code, which other zip codes are relatively close. As noted with respect to project type, zip code similarity is measured differently for projects involving labor and for projects involving product delivery. If the zip codes for the projects are similar, the new RFQ is eligible for aggregation.

If the new RFQ and the aggregated RFQ involve delivery of products, the method 300 determines if those products are in the same category. For example, if the new RFQ involves delivery of one or more touchpad devices, those devices should generally be from the same manufacturer (if the manufacturer would be the vendor 136). Alternatively, if a reseller would be the vendor 136, it is possible the touchpad devices could simply all be related to consumer electronics. If the products are in the same category, the new RFQ is eligible for aggregation.

At a step 314, the method 300 determines, for each green factor, that each each of the categories for which a “green rating” might be determined, whether the customer 126 with the new RFQ is concerned about using a vendor 136 with a particular green rating for that green factor. In this comparison, the method 300 operates with respect to each such green factor in logical parallel, with the effect that this issue is addressed if the customer 126 is concerned with a green rating for environmental concerns or any other green factor noted above (e.g., animal friendliness, child safety, human rights, etc.).
In each case, if the customer 126 is not concerned with that factor, the new RFQ is eligible for aggregation.
In each case, if the customer 126 is concerned about that factor, the method 300 determines if the new RFQ is similar, with respect to that factor, to the aggregated RFQ. In performing this action, the method 300 can use a database of “green ratings” for each such factor, or can determine the “green rating” for those factors for which the customer 126 is concerned, for the new RFQ and the aggregated RFQ, as described above for determining a “green rating” for the customer 126 themselves. This has the effect that if the customer 126 is concerned about that factor, the method 300 (such as when performed by the matching server 140) can separately address that concern by asking the customer 126 what the specific “green rating” is for that factor for the new RFQ, and can determine the “green rating” for that factor for the aggregated RFQ.
In each case, if the customer 126 is concerned about that factor, and the new RFQ is not similar to the aggregated RFQ, the new RFQ is not eligible for aggregation.
After reading this application, those skilled in the art will realize that the phrase “green factor” can be used for any factor for which the customer 126 is concerned, including environmental friendliness, animal friendliness, child safety, human rights, and any other factor noted herein. After reading this application, those skilled in the art will also realize that the method 300 does not operate on factors for which discrimination is prohibited by law.

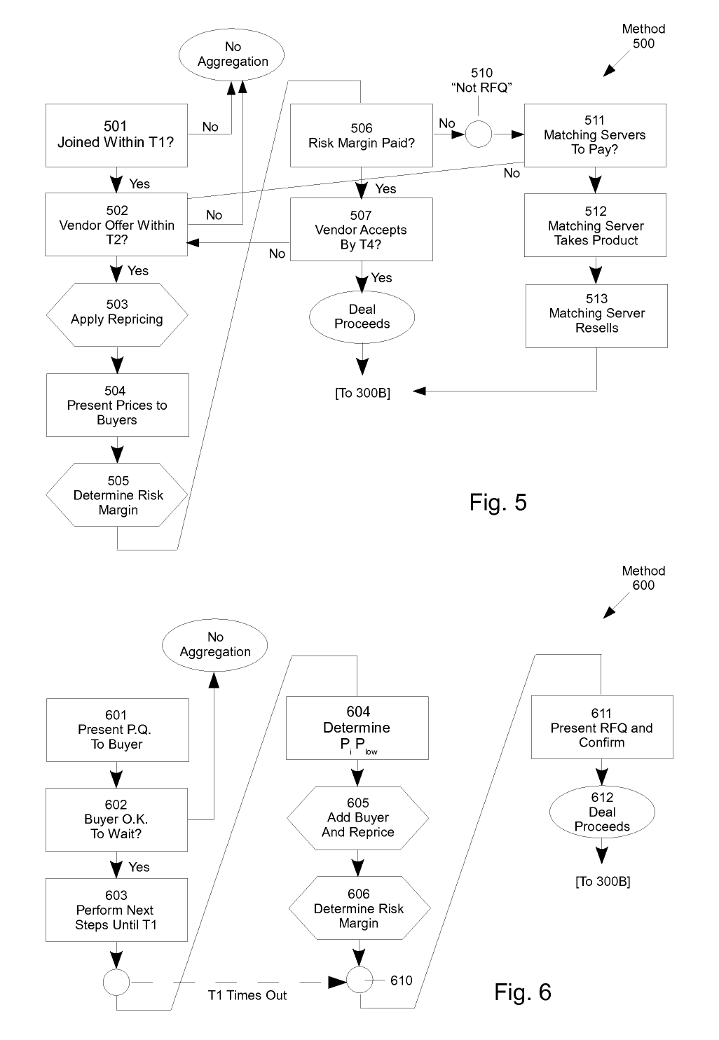

At a step 304, the matching server 140 determines the RFQ's type. If the RFQ is for a project for which bidding is with respect to time and materials, the method 300 performs the process described with respect to the FIG. 4. If the RFQ is for a commodity without tiered pricing, the method 300 performs the process described with respect to the FIG. 5. If the RFQ is for a commodity with tiered pricing, the method 300 performs the process described with respect to the FIG. 6.

A flow point 300B indicates an end of the method 300.

In one embodiment, the matching server 140 collects feedback regarding completion of the project, or delivery of the product, and updates its database regarding (1) reliability of customers 126 in participating in aggregated RFQ's, (2) reliability of vendors 136 in performing on RFQ's, and otherwise.

In one embodiment, the method 300 returns to the flow point 300A to repeat itself with another RFQ. The method 300 can proceed concurrently with any or all of these flow points and steps with distinct RFQ's, or even with the same RFQ so long as data consistency is maintained.

### Time and Materials

FIG. 4 shows a conceptual diagram of a method.

A method 400 includes steps as shown in the figure, including at least steps as described below.

At a step 401, the matching server 140 determines if any customers 126 joined the RFQ for aggregation within the T₁ deadline. If not, there is no aggregation, and the matching server 140 proceeds with a non-aggregated RFQ. If so, the matching server 140 proceeds with the next step.

At a step 402, the method 400 presents aggregated parameters to vendors 136.

At a step 403, the matching server 140 determines if any vendors 136 have made offers within the T₂ deadline. If not, there is no aggregation, and the matching server 140 proceeds with one or more non-aggregated RFQ's. If so, the matching server 140 proceeds with the next step.

At a step 404, the matching server 140 reviews responses to the RFQ (sometimes referred to herein as “quotes”) from vendors 136, determines which quotes are best, and if so, whether any quotes have an associated T₃ deadline (response to group offer). In one embodiment, the lowest price quote is considered the best quote. In one embodiment, the best quote is presented to buyers, but if any best quote times out or is withdrawn for any reason, the next-best quote will be presented to buyers.

At a step 405, the method 400 applies the aggregation repricing technique. In general, each aggregated RFQ involves an amount of savings to the aggregated customers 126 in response to the vendor 136 granting a discount for the aggregation. In one embodiment, the method 300 distributes the savings to the aggregated customers 126 in response to the quantity they contribute to the aggregated RFQ. This has the effect that those customers 126 who contribute the most volume get their pro rata share of the savings.

In one embodiment, the method 300 also distributes an additional savings bonus, such as a 5% preference, to the customer 126 who initiated the RFQ, sometimes called the “initiator” herein. This has the effect that the customer 126 to initiate the RFQ, which becomes an aggregated RFQ, is rewarded for creating the opportunity, and has the effect of encouraging customers 126 to create RFQ's. In one embodiment, the matching server 140 calculates pricing for each customer 126, applies an extra 5% discount for the initiator, and redistributes that 5% discount among the other customers 126. This has the effect that the initiator gets a somewhat larger share of the savings, and that the other customers 126 get a somewhat smaller share of the savings.

Optionally, the method 300 could reward some set of early customers 126, such as for example, those first customers who join before the matching server 140 determines that aggregation is likely to draw an aggregated vendor offer. The matching server 140 could make this determination in response to a statistical history of number of early customers 126 who have been needed in the past to draw an aggregated vendor offer, or in response to the presence of an actual vendor policy or an actual aggregated vendor offer, or in response (in the case of tiered pricing, as described below) to a size of those early RFQ's in comparison to the tiered pricing quantities.

In one embodiment, the matching server 140 determines the savings due to the aggregated RFQ, as shown in equation (421):

S=PQ−SUMᵢ(PₛQₛ) (421)
where S is the amount saved,
where P Q represents the price and quantity for the aggregated RFQ, and
where SUMᵢ (PᵢQᵢ) represents the total individual pricing for customers 126 i=1 to N, if the RFQ had remained un-aggregated

In one embodiment, each customer 126 is allocated its proportion of the amount saved, as shown in equation (422):

Sᵢ=S(Qᵢ/Q) (422)
where Sᵢ is the amount saved for customer 126 i, and
where Qᵢ/Q represents the fraction of total quantity for customer 126 i

After the extra 5% discount for the initiator (P′₁=95% P₁) and (S′=S−5% P₁Q₁), the redistributed prices are shown in equation (423):

P′ᵢ=Pᵢ((S′−S)/S) (423)
where P′ᵢ is the adjusted price for customer 126 i

At a step 406, the matching server 140 presents re-priced pricing to buyers.

At a step 407, the matching server 140 determines a risk margin value for each buyer associated with the aggregated RFQ, and collects that risk margin from each buyer. As noted above, payment of the risk margin is optional with the buyer, but might contribute to whether the vendor decides to proceed with the aggregated RFQ, and if not paid, subjects the buyer to being removed from the aggregated RFQ.

In one embodiment, the matching server 140 determines a risk margin as described below. While this application primarily describes a system in which the matching server 140 determines the risk margin, in the context of the invention, there is no particular requirement for any such limitation. For example, the risk margin could be set by the vendor 136, either in response to a desired profit margin, or in response to statistical experience with the matching server 140, or otherwise.

In one embodiment, the matching server 140 determines a measure of risk associated with aggregated RFQ. More specifically, the matching server 140 calculates a risk margin associated with the aggregated RFQ, in response to a measure of “trustworthiness” of the buyers.

When the matching server 140 selects an aggregated RFQ for presentation to a particular vendor 136, the matching server 140 informs the vendor 136 of the risk margin it calculated. This has the effect that when the vendor 136 attempts to account for the risk associated with only partial acceptance of the vendor's group offer, the vendor 136 has a numerical amount of possible profit considered to be at risk. When the aggregated RFQ is presented to the vendor 136, the vendor 136 can use that risk margin to determine its desired profit margin, or to determine pricing it is willing to make part of its group offer. The vender 136 can instead use its own determination of possible risk, either in its own calculation of a desired profit margin, or to determine pricing, or both, or otherwise.

In one embodiment, the matching server 140 calculated a trustworthiness value for each customer 126 involved in the aggregated RFQ. In one embodiment, the trustworthiness value is responsive to the credit score for the customer 126. However, the trustworthiness value can also be responsive to a record of whether the customer 126 has participated in past aggregated RFQ's. In one embodiment, the trustworthiness value for a customer 126 can be calculated as shown in equation (431):

RCₓ=(maximum credit score−customer credit score)/(maximum credit score) (431)
where the result RCₓ is a value within the range [0, 1].

In one embodiment, the risk margin RC for the aggregated RFQ can be calculated as shown in equation (432).

RC=(industry standard profit margin)*F(N)*SUMᵢ(Qᵢ/Q)RCᵢ (432)
where F(N) is a function of N, the total number of customers 126 involved in the aggregated RFQ, that decreases with N, to reflect increased risk when there are more customers 126 that might drop out;
and where the SUMᵢ represents that the value (Qᵢ/Q) RCᵢ is summed for all customers 126 involved in the aggregated RFQ.

At a step 408, the matching server 140 determines if the risk margin was timely paid by the T₃ deadline (for accepting vendor offers) set by the vendor 136. If so, the method 400 proceeds with the next step. If not, the matching server 140 removes those buyers who did not pay the risk margin from the aggregated RFQ, and returns to the step 402, where it presents the revised aggregated RFQ to vendors 136 for offers.

At a step 409, the matching server 140 determines if the T₄ deadline (for ratifying vendor offers) was timely met by the vendor 136. If so, the deal proceeds as in the aggregated RFQ. If not, the aggregated RFQ fails to proceed, and the matching server 140 returns to the step 403, where it determines if there are any vendor offers within the T₂ deadline, which are still possible to proceed with.

At a step 410, the deal proceeds as in the aggregated RFQ. After the deal proceeds as in the aggregated RFQ, the method 400 returns to the flow point 500B in the method 300.

### Commodity without Tiered Pricing

FIG. 5 shows a conceptual diagram of a method.

A method 500 includes steps as shown in the figure, including at least steps as described below.

At a step 501, the matching server 140 determines if any customers 126 joined the RFQ for aggregation within the T₁ deadline. If not, there is no aggregation, and the matching server 140 proceeds with a non-aggregated RFQ. If so, the matching server 140 proceeds with the next step.

In general, in a “without tiered pricing” project, the vendor 136 determines a discount price that it will honor if the amount of product ordered exceeds a minimum quantity (Qₘᵢₙ). In many cases, the vendor 136 does not present tiered pricing and is usually the only one providing this particular product or commodity. For example, a touchpad manufacturer with a product normally selling for $500 each might offer that product at $400 each, but only if buyers commit to collectively purchase at least 1,000 units.

At a step 502, the determines if it has received a vendor offer with a price (P_{aggregated}), less than retail price (Pᵣₑₜₐᵢₗ), and commitment quantity (Qₘᵢₙ), within the T₂ deadline. If not, there is no aggregation, and the matching server 140 proceeds with one or more non-aggregated RFQ's. If so, the matching server 140 proceeds with the next step.

At a step 503, the matching server 140 applies the aggregation repricing technique as described herein with respect to the step 405.

At a step 504, the matching server 140 presents re-priced pricing to buyers. At a step 505, the matching server 140 determines a risk margin value for each buyer associated with the aggregated RFQ, as described herein with respect to the step 407, and collects that risk margin from each buyer. As noted above, payment of the risk margin is optional with the buyer, but might contribute to whether the vendor decides to proceed with the aggregated RFQ, and if not paid, subjects the buyer to being removed from the aggregated RFQ.

At a step 506, the matching server 140 determines if the risk margin was timely paid by the T₃ deadline (for accepting vendor offers) set by the vendor 136. If so, the method 400 proceeds with the next step. If not, the matching server 140 removes those buyers who did not pay the risk margin from the aggregated RFQ, and proceeds with the flow point 510, where the “hot RFQ” technique is performed.

At a step 507, the matching server 140 determines if the T₄ deadline (for ratifying vendor offers) was timely met by the vendor 136. If so, the deal proceeds as in the aggregated RFQ. If not, the aggregated RFQ fails to proceed, and the matching server 140 returns to the step 502, where it determines if there are any vendor offers within the T₂ deadline, which are still possible to proceed with.

At a step 508, the deal proceeds as in the aggregated RFQ. After the deal proceeds as in the aggregated RFQ, the method 400 returns to the flow point 500B in the method 300.

At the flow point 510, the method 500 is ready to perform the “hot RFQ” technique.

At a step 511, the matching server 140 determines if its own operators are willing to pay the risk margin in lieu of buyers. If not, the aggregated RFQ fails to proceed, and the matching server 140 returns to the step 502, where it determines if there are any vendor offers within the T₂ deadline, which are still possible to proceed with. If so, the method 500 proceeds with the next step.

At a step 512, the matching server 140 commits to purchase the uncommitted units of the product, taking delivery if necessary. The matching server 140 declares that the deal will proceed as in the aggregated RFQ. The method 500 proceeds in parallel with the step 508 and the step 513. This has the effect that the deal proceeds in parallel with the “hot RFQ” technique.

At a step 513, the matching server 140 offers the uncommitted units of the product at a price (P_{hotRFQ}) which is less than retail price (Pᵣₑₜₐᵢₗ), but no less than the aggregated RFQ price (P_{aggregated}). This has the effect that the matching server 140 itself can profit from the uncommitted units.

After the “hot RFQ” technique is finished, the method 500 proceeds with the flow point 500B, where the method 300 is finished.

### Commodity with Tiered Pricing

FIG. 6 shows a conceptual diagram of a method.

A method 600 includes steps as shown in the figure, including at least steps as described below.

In general, in a “tiered pricing” project, the vendor 136 has determined a set of prices (usually involving price discounts) that it has set if the amount of product ordered exceeds selected levels. For example, a vendor 136, such as a laptop reseller, with a product normally selling for $1,000 each, might offer that product at $900 each if buyers commit to collectively purchasing at least 500 units, $800 each if buyers commit to collectively purchasing at least 1,000 units, and $750 each if buyers commit to collectively purchasing at least 1,500 units. The vendor 136 might have a COGS (cost of goods sold) which allows it to price better when there is a larger order, as its total profit from the deal is sufficient. The tiered prices and quantities are referred to in this section as Pᵢ and Qᵢ respectively.

At a step 601, the matching server 140 presents a set of tiered pricing Pᵢ and Qᵢ to the buyer.

At a step 602, the matching server 140 determines, for each buyer, if the buyer is willing to wait for an aggregated RFQ to be constructed for the tiered pricing. If those buyers are not willing to wait for aggregation, they each proceed with a non-aggregated RFQ. If so, the matching server 140 proceeds with the next step.

At a step 603, the matching server 140 determines, for each buyer, its T₁ deadline (time for aggregation). The matching server 140 performs aggregation, as described below until the flow point 610, until the earliest T₁ deadline, after which the aggregated RFQ is constructed and that deal proceeds as in the aggregated RFQ.

At a step 604, the matching server 140 presents the current retail price Pᵣₑₜₐᵢₗ and the lowest possible tiered price P_{low} to buyers.

At a step 605, as each buyer selects a new quantity Qᵢ to purchase, the matching server 140 applies a repricing technique for tiered pricing and presents a revised price P_{new} to buyers. If those new buyers do not enter the aggregated RFQ, the matching server 140 proceeds with the buyer's quantity, selects an associated Pᵢ and Qᵢ, and proceeds with the deal at the flow point 370. If so, the matching server 140 proceeds with the next step.

In one embodiment, the repricing technique for tiered pricing provides the following features:
Each time a new buyer is added to the aggregated RFQ, the repricing technique for tiered pricing is applied.
The revised price P_{new} presented to each buyer is always equal to or better than the retail price Pᵣₑₜₐᵢₗ available if that buyer were the only one involved in making the tiered pricing purchase from the vendor 136.
The revised price P_{new} presented to each buyer is responsive to the total quantity Qₜₒₜₐₗ presented to the vendor due to the aggregation of buyers.
The revised price P_{new} presented to each buyer is responsive to the quantity Q_{new} added by the new buyer, according to equation (621):

P_{new}=(Pᵣₑₜₐᵢₗ−P_{aggregated})*(1−exp(k*(Pᵣₑₜₐᵢₗ−P_{aggregated}))) (621)
where P_{new} is the revised price, Pᵣₑₜₐᵢₗ is the retail price, and P_{aggregated} is the price due to aggregation,
where exp is the exponential function e^{x},
where k is a constant coefficient, selected by the matching server 140, with the effect of apportioning the amount of savings among buyers, and between buyers and the matching server 140 itself
This has the effect that the savings afforded to each new buyer (when that buyer pays the risk margin) is larger when the new buyer provides more savings to other buyers due to aggregation.
The revised price P_{new} is further adjusted by allocating 5% of the savings Pᵣₑₜₐᵢₗ−P_{aggregated} to the initiating buyer, that is, the 1^{st} buyer to request the product. The matching server 140 allocates 5% of the savings Pᵣₑₜₐᵢₗ−P_{aggregated} to the initiating buyer to encourage buyers to create new RFQ's which might become aggregated RFQ's.
In one embodiment, if the new buyer has a desired quantity (Q_{new}) which is so large that other buyers are not needed for the aggregated RFQ, the new buyer is reallocated to a separate and new aggregated RFQ, because all the savings for the old aggregated RFQ would otherwise be substantially entirely allocated to the new buyer, the other buyers would not save anything, and there would be nearly no opportunity for the matching server 140 to collect any of the difference. The matching server 140 could determine statistically whether a new buyer's requested quantity (Q_{new}) is too large, even if that new quantity (Q_{new}) is not actually enough to overflow the tiered pricing presented by the vendor.

At a step 606, the matching server 140 determines the risk margin for the new buyer, as described with respect to the step 407. If the new buyer declines to pay the risk margin, the new buyer is added to a set of possible participants in the aggregated RFQ, but tiered pricing Pᵢ and Qᵢ are not updated. If the new buyer does pay the risk margin, tiered prices and quantities Pᵢ and Qᵢ are updated, including updating tiered pricing for all buyers already part of the aggregated RFQ.

At a flow point 610, the aggregation time T₁ has passed, or all buyers declare they are no longer willing to wait for further aggregation.

At a step 611, the matching server 140 presents the aggregated RFQ (or a single RFQ if there is only one buyer) to all buyers, including prices and quantities Pᵢ and Qᵢ, and orders by buyers are confirmed.

At a step 612, the deal proceeds as an the aggregated RFQ. After the deal proceeds as in the aggregated RFQ, the method 400 returns to the flow point 300B in the method 300.

1. A computer-implemented method performed by a server, comprising:
receiving a 1st request for quote from a 1st customer over a network;
associating, a 1st value of a green factor with said 1st request for quote;
receiving a 2nd request for quote from a 2nd customer over the network;
associating a 2nd value of the green factor with said 2nd request for quote;
determining whether to aggregate said 1st request for quote and said 2nd request for quote;
aggregating said 1st request for quote and said 2nd request for quote into an aggregated request for quote when said step of determining determines that the 1st and 2nd requests for quotes are to be aggregated;
storing the aggregated request for quote in a memory coupled to the server;
associating a vendor offer with said stored aggregated request for quote;
wherein said vendor offer provides a better rate to said 1st customer than available in response to said 1st request for quote; and
wherein said step of determining comprises steps of:
rejecting aggregation when said 1st value of said green factor differs from said 2nd value of said green factor by more than a rating difference, and wherein said rating difference is responsive to preferences expressed for said green factor by said 1st customer and said 2nd customer.

2. A computer-implemented method as in claim 1,
wherein acceptance of said vendor offer is responsive to meeting a minimum quantity for purchase;
and comprising:
by a service, committing, to purchase enough products or services to meet said minimum quantity;
by said service, offering, said products or services at not less than a price associated with said aggregated vendor order;
wherein said service profits from facilitating said aggregated vendor order.

3. A computer-implemented method as in claim 2, wherein
said of committing, to purchase comprises, by said service, paying a risk margin associated with said aggregated vendor order.

4. A computer-implemented method as in claim 2, wherein
said service obtains risk margin payments before performing said steps of committing to purchase.

5. A computer-implemented method as in claim 2, wherein
said service obtains customer orders for said products or services before performing said step of committing to purchase.

6. A computer-implemented method as in claim 1, further comprising:
receiving, in response to said vendor offer, one or more acceptances by customers associated with said aggregated request for quote;
in response to each said acceptance, allocating selected portions of price savings to customers having accepted said vendor offer;
wherein said selected portions of price savings comprise one or more components that are not directly proportional to customer's portions of said vendor offer.

7. A computer-implemented method as in claim 6, wherein
said components comprise one or more of:
a different risk margin charged to distinct customers,
whether particular customer have paid their associated risk margin.

8. A computer-implemented method as in claim 6, wherein
said components comprise a bonus portion reserved for an earliest customer to submit a request for quote.

9. A computer-implemented method as in claim 6, wherein
said components comprise a portion reserved for a service.

10. A computer-implemented method as in claim 1, further comprising:
evaluating a vendor green factor; and
rejecting aggregation when said vendor green factor differs from said 1st value or said 2nd value of said green factor by more than the rating difference.

11. A computer method as in claim 10, wherein
said step of evaluating a vendor green factor are responsive to one or more of:
a reputation poll of said vendor by customers;
a statistical measure of values of green factors of past customers of said vendor;
a statistical measure of values of green factors of products or services offered by said vendor; and
an evaluation of said vendor by a rating agency.

12. A computer-implemented method as in claim 1 further comprising:
evaluating said 1st value of said green factor in response to steps of:
presenting choices to said 1st customer;
receiving responses from said 1st customer;
repeating said steps of presenting choices and receiving responses until reaching a selected confidence for said 1st value of said green factor.

13. A computer-implemented method as in claim 12, wherein
said step of evaluating is responsive to information about said 1st customer and information about said 1st request for quote.

14. A computer-implemented method as in claim 12, further comprising:
evaluating said 1st value of said green factor in response to steps of
associating a default 1st value of said green rating, with said 1st customer;
adjusting said 1st value of said green factor in response to information about said 1st customer;
repeating said step of adjusting until reaching a selected confidence for said 1st value of said green factor.

15. A computer-implemented method as in claim 12, further comprising:
evaluating said 1st value of said green rating in response to steps of:
selecting one or more questions from a database of questions, said selected questions bearing on evaluation of said 1st value of said green factor; and
obtaining answers to said selected questions.

16. A computer-implemented method as in claim 12, wherein said choices and responses elicit information about one or more of
factors which directly pertain to said green factor;
factors which indirectly pertain to said green factor; and
factors which are statistically correlated with customers having known values for said green factor.

17. A computer-implemented method as in claim 1 further comprising:
associating a risk margin with said 2nd request for quote;
wherein said risk margin is less than a full price for 2nd request for quote;
wherein said steps of determining further comprises:
rejecting aggregation when said 2nd customer does not pay said risk margin.

18. A computer-implemented method as in claim 17 further comprising:
determining, said risk margin in response to both a number of customers associated with said aggregated request for quote, and a proportion of said aggregated request for quote associated with customers;
Wherein said risk margin is less per customer in response to more customers associated with said aggregated request for quote, and is more for customers with a larger proportion of said aggregated request for quote.

19. A computer-implemented method as in claim 17, further comprising:
retaining at least a portion of paid risk margin by a server.

20. A computer-implemented, method as in claim 17, further comprising:
presenting said determined risk margin to one or more vendors before receiving said vendor to enable the at least one vendor to determine its vendor offer in response to said determined risk margin.

21. A computer-implemented method as in claim 17, further comprising:
determining said risk margin in response to a credit score associated with said 2nd customer.

22. A computer-implemented method as in claim 17, further comprising:
determining said risk margin in response to a measure of risk that said 2nd customer might not participate in said vendor offer.

23. A computer-implemented method as in claim 17, further comprising:
determining said risk margin in response to a profit margin selected by one or more vendors.

24. A computer-implemented method as in claim 17, further comprising:
determining said risk margin in response to a profit margin associated with a prospective aggregated request for quote.

25. A computer-implemented, method as in claim 1, wherein
said 1st request for quote is associated with a 1st product or service;
said 2nd request for quote is associated with a 2nd product or service;
and wherein determining comprises:
presenting an alternative 2nd product or service to said 2nd customer; and
receiving feedback from said 2nd customer in response to said alternative 2nd product or service.

26. A computer-implemented method as in claim 1, wherein
said step of determining is responsive to
a set of goals desired by said 1st customer, said goals including at least one of capacity needs, compliance requirements;
a set of costs willing to be incurred by said 1st customer, said costs including at least two of recurring monetary cost, energy usage, carbon footprint; and
a degree of effort willing to be expended by said 1st customer, said effort including at least two of capital investment, time to completion, and said green factor.

27. A computer-implemented method as in claim 1, wherein
said green factor comprises one or more of environmental friendliness, animal friendliness, child safety, human rights, minority-owned businesses, political standing, and religious affiliation.

28. A computer-implemented method as in claim 1, wherein
said 1st request for quote is associated with a 1st location and a 1st type of project; and
said 2nd request for quote is associated with a 2nd location and a 2nd type of project;
wherein determining further comprises:
rejecting aggregation when said 1st location differs from said 2nd location by more than a selected distance,
said selected distance being responsive to said 1st type of project and said 2nd type of project.

29. A computer-implemented method as in claim 28, wherein
said selected distance is responsive to a shipping distance when said 1st type of project includes materials delivery.

30. A computer-implemented method as in claim 28, wherein
said selected distance is responsive to a driving distance when said 1st type of project includes labor.

31. A computer-implemented method as in claim 1, wherein determining comprises:
receiving a time limit to aggregate from said 1st customer; and
rejecting aggregation when said 2nd request for quote is received after said time limit.

32. A computer-implemented method as in claim 1, wherein
said 1st customer is associated with a 1st value of a 2nd green factor; and
said 1st customer is associated with a 2nd value of a 2nd green factor;
wherein determining comprises:
rejecting aggregation when said 1st value of said 2nd green factor differs from said 2nd value of said 2nd green factor by more than a 2nd rating difference, wherein said 2nd rating difference is responsive to preferences expressed for said 2nd green factor by said 1st customer and said 2nd customer.

33. A machine-readable storage medium having data stored thereon representing sequences of instructions which, when executed by one or more physical computers coupled to a computer network, causes at least one of the computers to:
receive a first request for quote and a second request for quote from a first customer and a second customer, respectively, over the computer network;
associate a first value of a green factor with the received first request for quote and associate a second value of the green factor with the received second request for quote and store the first value of the green factor and the second value of the green factor in a memory coupled to the server;
aggregate at least the first request for quote and the second request for quote into an aggregated request for quote when the stored first value of the green factor does not differ from the stored second value of the green factor by more than a rating difference, the rating difference being response to preferences expressed thr the green factor by the first customer and the second customer;
store the aggregated request for quote in the memory; and
associate a vendor offer with the stored aggregated request for quote; the vendor offer providing a better rate to the first customer than available in response to the first request for quote.

34. A device configured to couple to a computer network, the device comprising:
a memory;
a processor coupled to the memory, the processor being configured to:
receive a first request for quote and a second request for quote from a first customer and a second customer, respectively, over the computer network;
associate a first value of a green factor with the received first request for quote and associate a second value of the green factor with the received second request for quote;
store the first value of the green factor and the second value of the green factor in the memory;
aggregate at least the first request for quote and the second request for quote into an aggregated request for quote when the stored first value of the green factor does not differ from the stored second value of the green factor by more than a rating difference that is responsive to preferences expressed for the green factor by the first and the second customers;
store the aggregated request for quote in the memory; and
associate a vendor offer with the stored aggregated request for quote; the vendor offer being configured to provide a better rate to the first customer than available in response to the first request for quote.
